(19) United States
(12) Patent Application Publication
(10) Pub. No.: US 2026/0116165 A1
(43) Pub. Date: Apr. 30, 2026

(54) DRIVE ASSEMBLY FOR A MOTOR VEHICLE

(71) Applicant: Ford Global Technologies, LLC, Dearborn, MI (US)

(72) Inventors: Roger GRAAF, Vaals (NL); Daniel MAINZ, Herzogenrath (DE); Rainer SOUSCHEK, Aachen (DE); Paul ZANDBERGEN, Wurselen (DE); Marcus KALABIS, Krefeld (DE); Matthias DEHMEL, Pulheim (DE); Ralf HINTZEN, Aachen (DE); Nicole ZANDBERGEN, Wurselen (DE); Thomas GERHARDS, Niederzier (DE); Bjoern REFF, Koeln (DE)

(21) Appl. No.: 19/371,245

(22) Filed: Oct. 28, 2025

(30) Foreign Application Priority Data
Oct. 28, 2024 (DE) 102024131313.7

(51) Int. Cl. B60K 1/02; B60G 17/015; B60K 17/08; H02K 7/116

(52) U.S. Cl. CPC B60K 1/02; B60G 17/015; B60K 17/08; H02K 7/116; B60G 2202/42; B60G 2300/50; B60G 2500/20

(57) ABSTRACT

A drive assembly for a motor vehicle may include a wheel shaft for non-rotatable connection to a vehicle wheel, a bearing unit for arrangement on a vehicle body, a first electric motor having a primary stator element and a primary rotor element, and a second electric motor having a secondary stator element and a secondary rotor element. The stator element and the rotor element of each electric motor are rotatable relative to one another. The rotor elements are coupled in a movement-transmitting manner to the wheel shaft. The stator elements are mounted so as to be individually rotatable relative to the bearing unit and are connected via a coupling gear. The secondary stator element is coupled in a movement-transmitting manner to a spring element for the suspension of the vehicle wheel.

### TECHNICAL FIELD

Example embodiments generally relate to a drive assembly for a motor vehicle.

### BACKGROUND

In motor vehicles such as passenger cars or trucks, various actuators or motors are used to carry out different functions of the chassis. The driven wheels are either driven via a central motor and intermediate gear components or, in the case of electric vehicles, are optionally also driven via motors associated with the individual wheels. Hydraulic or electric actuators for braking the individual wheels are further provided. It is additionally known to provide an adaptive or active suspension, the effective spring constant between a vehicle wheel and the vehicle body being influenced via an actuator. Hydraulic or electric actuators, for example, can be used for this purpose. Although the mentioned systems are necessary or at least expedient, the actuator systems existing in parallel increase the complexity, they occupy a large amount of installation space, and the vehicle mass increases. Moreover, integration of the different systems can force compromises, which entail lower efficiency and thus, ultimately, a non-optimal ride quality.

U.S. Pat. No. 6,386,553 B2 discloses an arrangement for the suspension of a wheel in a motor vehicle, wherein the wheel is equipped with a propulsion device for driving the vehicle and with a braking device for braking each individual wheel. The arrangement has sensors for detecting the steering angle to be performed by the vehicle driver, two steering link arms fitted between the chassis and the attachment points in the wheel, and a control unit for processing the signals coming from the sensors and for actuating the steering link arms for the purpose of adjusting the wheel in response to the signals and the current operating state of the vehicle. Each steering link arm has an electrically operated axial motor and a displaceably mounted rod connected to the wheel.

In light of the indicated prior art, the efficient performance of various actuator-based functions in a vehicle wheel still leaves room for improvement. It would be desirable in particular to minimize the required installation space as well as the mass of the necessary components.

### BRIEF SUMMARY OF SOME EXAMPLES

The disclosure relates to providing various actuator-based functions in a vehicle wheel in an efficient manner.

This may be achieved by a drive assembly for a motor vehicle, having a wheel shaft for non-rotatable connection to a vehicle wheel, a bearing unit for arrangement on a vehicle body, a first electric motor having a primary stator element and a primary rotor element, and a second electric motor having a secondary stator element and a secondary rotor element. The stator element and the rotor element of each electric motor are rotatable relative to one another. The rotor elements are coupled in a movement-transmitting manner to the wheel shaft. The stator elements are mounted so as to be individually rotatable relative to the bearing unit and are connected via a coupling gear. The secondary stator element is coupled in a movement-transmitting manner to a spring element for the suspension of the vehicle wheel.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a schematic top view of a first embodiment of a drive assembly according to an example embodiment;

FIG. 2 shows a schematic diagram illustrating torque in the drive assembly according to an example embodiment;

FIG. 3 shows a schematic diagram illustrating torque in the drive assembly according to an example embodiment;

FIG. 4 shows a schematic diagram illustrating torque in the drive assembly according to an example embodiment; and

FIG. 5 shows a schematic diagram illustrating torque in the drive assembly according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other. It should be noted that the features and measures presented individually in the following description can be combined in any technically feasible manner, giving rise to further embodiments of the invention. The description additionally characterizes and specifies aspects of some example embodiments, particularly in conjunction with the figures. It should be noted that the features and measures mentioned individually in the following description can be combined with one another in any technically expedient manner and reveal further embodiments of the invention. The description additionally characterizes and specifies the invention in particular in conjunction with the figures. The terms “first”, “second”, etc. used in this description serve merely for the purpose of distinction. In particular, the use of these terms is not to imply any order or priority of the elements or objects mentioned in connection therewith.

Some example embodiments may provide a drive assembly for a motor vehicle. The motor vehicle may be a vehicle with at least two axles, at least one of which has two wheels. It can be, for example, a truck or a passenger car. The expression “drive assembly” indicates that this assembly contributes at least partially to driving the motor vehicle, wherein it also fulfils at least one further function, as will be explained below.

The drive assembly may have a wheel shaft for non-rotatable connection to a vehicle wheel. The wheel shaft is provided to be non-rotatably connected to the vehicle wheel so that a rotational movement of the wheel shaft is transmitted to the vehicle wheel. The vehicle wheel itself can be rotatably mounted on a wheel carrier, for example. It can be regarded as part of the drive assembly. The wheel shaft can be configured so as to be in one piece and rigid, but it can also have, for example, a Cardan shaft and/or telescopic shaft and thus be adjustable at least to a limited extent.

The drive assembly further has a bearing unit for arrangement on a vehicle body. That is to say, the bearing unit is provided and configured for arrangement on the vehicle body. In this context, “vehicle body” is a blanket term for an automotive body, a chassis and optionally a sub-frame of the vehicle in question, that is to say those parts that normally form the sprung mass. The bearing unit can be provided in particular to be fastened to the vehicle body. This also includes the possibility of at least partial integration in the vehicle body. The bearing unit is preferably configured so as to be rigid in itself, wherein it can consist of one or more mutually connected parts. Multiple components, which are to be mentioned below, are movably mounted thereon. It can be configured so as to be wholly or partially closed, wherein it may also be referred to at least in some embodiments as a housing unit or housing.

The drive assembly further has a first electric motor and a second electric motor. The electric motors can in particular be motors that can be operated with a high voltage of over 48 V, for example at least 200 V or at least 400 V. Both motors are rotary electric motors. The first electric motor has a primary stator element and a primary rotor element, while the second electric motor has a secondary stator element and a secondary rotor element, wherein the stator element and the rotor element of each electric motor are rotatable relative to one another. As already stated above, the terms “first”, “second”, “secondary” and “primary” serve merely for terminological distinction and do not imply any arrangement or any size or performance ratio. The rotor element and the associated stator element are rotatable relative to one another. Thus, one of the elements can be regarded as the (primary or secondary) stator and the other as the (primary or secondary) rotor. The term “stator” in connection with the present invention is not to be understood as meaning that this component is stationary relative to the bearing unit, as will be explained below. However, in the operating state, the stators in some cases move less frequently, more slowly and/or in a smaller angle range than the rotors. In this respect, it would also be possible at least in some embodiments to refer to a (primary or secondary) quasi-stator. In particular, the stator element can form a stator or quasi-stator, while the rotor element forms a rotor. It would, however, also be conceivable for the stator element to form a rotor, while the rotor element forms a stator or quasi-stator.

The rotor elements may be operably coupled in a movement-transmitting manner to the wheel shaft, and the stator elements are mounted so as to be individually rotatable relative to the bearing unit and are connected via a coupling gear. Here and in the following, “coupled in a movement-transmitting manner” means that a movement of one component brings about a movement of the other component. Coupling can be direct or indirect. The coupling can also involve a change in the movement direction, the movement type (rotational and/or translational) as well as a speed reduction or increase. In this case, a movement of the rotor elements leads to a movement of the wheel shaft. The coupling of the two rotor elements to the wheel shaft also involves the two rotor elements being coupled in a movement-transmitting manner to one another. The wheel shaft can be said to be drivable via both rotor elements. However, conversely, for example in the case of a braking operation, the rotor elements can be driven by the wheel shaft. The two rotor elements are rotatably mounted relative to the bearing unit. For the rotatable mounting, the bearing unit can have sliding bearings or rolling bearings, for example. The primary stator element and the secondary stator element are mounted so as to be individually rotatable relative to the bearing unit. That is to say, each stator element is mounted separately. Accordingly, the stator elements are movable relative to one another. The primary and secondary stator elements can be mounted coaxially, but this is not necessarily the case. The two stator elements are not wholly independent of one another. Rather, they are connected via an intermediate coupling gear. A movement-transmitting coupling can be provided by the coupling gear. In particular, a torque acting on one stator element can lead, via the intermediate coupling gear, to a torque on the other stator element. There is thus a mechanical interaction between the stator elements, even though they are electrically independent of one another.

Furthermore, the second stator element may be operably coupled in a movement-transmitting manner to a spring element for the suspension of the vehicle wheel. The spring element is generally configured for the suspension of the vehicle wheel or for the spring-mounted connection of the vehicle wheel to the vehicle body. In the installed state, it is typically provided that the spring element does not act directly on the vehicle wheel or on the wheel shaft but acts on a wheel suspension element that is deflectable relative to the vehicle body, for example on a wheel carrier or on a control arm (transverse control arm, longitudinal control arm or semi-trailing arm), by means of which the wheel carrier is connected to the vehicle body. Typically, such a wheel suspension element is deflectable relative to the vehicle body at least with respect to the vehicle vertical axis (Z-axis). In addition, there can also be partial deflectability with respect to the vehicle longitudinal axis (X-axis) and/or the vehicle transverse axis (Y-axis). The spring element is configured to generate a spring force. This includes the possibility that the spring element first generates a torque by means of which a force acting on the vehicle wheel is generated. The spring element can have a portion on the wheel side and a portion on the vehicle side, wherein the spring force and/or the torque depend/depends on the relative position of the two portions. The secondary stator element is coupled to the spring element, for example to the portion on the vehicle side, so that this is deflectable by the movement of the secondary stator element. This in turn results in active influencing of the spring element. Active suspension, or active influencing of the position, of the wheel suspension element (and thus of the vehicle wheel) is thus possible. Influencing of the spring force by means of actuators is known in principle. In the solution according to the invention, however, the deflection is generated not by the second electric motor alone but by both electric motors. This is achieved by the coupling of the two stator elements via the coupling gear.

In the drive assembly according to an example embodiment, two electric motors are provided for two functions, namely for driving the vehicle wheel and for adjusting the spring force. However, there is no one-to-one association, but both electric motors are associated with both functions. On the one hand, the two rotor elements cooperate to drive the wheel shaft. On the other hand, the two stator elements cooperate (via the coupling gear) to deflect the spring element. By suitably activating both motors, the joint action can be increased if required, for example in order to generate a strong driving torque in the wheel shaft. Since both motors are electric motors, which can also act as generators, the drive assembly can also be used to brake the wheel shaft and thus the vehicle wheel electromagnetically. Although a friction brake may additionally be necessary, this can be designed to be smaller and/or less powerful, since its action is supplemented by the electromagnetic brake. As a result of the cooperative action of the two electric motors, installation space and weight can be minimized. Operation of the electric motors is possible without the complex installation of hydraulic lines or the like. They simply require an electrical connection to a power source, for example a battery unit or optionally a fuel cell of the motor vehicle. A further advantage is that, even in the event of failure of one of the electric motors, the vehicle wheel can still be driven by the other electric motor. In this case, it is no longer possible to independently adjust the spring force, but this is acceptable in the case of emergency operation.

The rotor elements can be coupled to one another via an intermediate transmission, which could impart, for example, a speed increase or reduction. An example embodiment provides that the rotor elements are non-rotatably connected to one another. In particular, they can be connected via a rotor shaft. A direct connection of the two rotor elements would also be possible. In this context, it could also be that a clear physical delimitation of the two rotor elements is not possible and that they can be regarded as portions of a single rotor.

As regards the coupling of the stator elements, there are different possibilities. Although movement transmission is possible via the coupling gear, the angular velocities, or rotational speeds, of the stator elements can differ. For example, the stator elements can be coupled in a movement-transmitting manner via the coupling gear such that a speed increase takes place from the primary stator element to the secondary stator element. That is to say, the angular velocity of the secondary stator element is always greater (in terms of amount) than that of the primary stator element. On the other hand, a torque acting between the coupling gear and the primary stator element corresponds to a lower torque acting between the coupling gear and the secondary stator element.

In an example embodiment, the coupling gear is configured as a planetary gear, which has as gear parts a ring gear, a planet carrier with a plurality of planet gears, and a sun gear. The construction of a planetary gear is known in principle. It has as the outer gear part the ring gear, as the middle gear part the planet carrier with the planet gears rotatably mounted thereon, which mesh with the ring gear, and as the inner gear part the sun gear, which in turn meshes with the planet gears. The three gear parts are rotatable relative to one another, wherein the movement of two gear parts in each case determines the movement of the third gear part.

In particular, the primary stator element can be non-rotatably connected to a first gear part, the secondary stator element can be non-rotatably connected to a second gear part, and a third gear part can be non-rotatably connected to the bearing unit. That is to say, one of the gear parts (ring gear, planet carrier or sun gear) is connected in a stationary manner to the bearing unit, while the two remaining gear parts are each non-rotatably connected to one of the stator elements. In this embodiment, it is also possible for the respective gear part to be formed, at least in part, integrally with the primary stator element, the secondary stator element or the bearing unit, so that no clear physical delimitation is possible.

With regard to the above-mentioned embodiment, six combinations are possible in total, all of which can in principle be used expediently. Preference is given to an embodiment according to which the primary stator element is non-rotatably connected to the ring gear, the secondary stator element is non-rotatably connected to the sun gear, and the planet carrier is non-rotatably connected to the bearing unit. The ring gear with the primary stator element and the sun gear with the secondary stator element are rotatable relative to the bearing unit. By contrast, the planet carrier is configured so as to be stationary relative to the bearing unit and can optionally be integrated therein. The planet gears, on the other hand, are of course rotatable relative to the bearing unit. Since the ring gear has a larger diameter than the sun gear, a speed increase takes place in this embodiment from the primary stator element to the secondary stator element.

As already mentioned, the spring element can be configured in different ways. Possible configurations would be, for example, as a helical spring or as a leaf spring. According to one embodiment, the spring element has a torsion portion, to which the secondary stator element is coupled in a movement-transmitting manner. The torsion portion is torsionable by an acting torsional moment, wherein the extent of the torsion depends on the position of the vehicle wheel relative to the vehicle body and on the status of the secondary stator element. The secondary stator element is connected either directly or indirectly to the torsion portion, in particular to a region of the torsion portion on the vehicle side. A region of the torsion portion on the wheel side can be connected directly or indirectly to the vehicle wheel or to the above-mentioned wheel suspension element. In particular, a lever portion of the spring element that runs at an angle to the torsion portion can be coupled at least indirectly to the wheel suspension element.

In view of a torque that is expedient for accelerating the motor vehicle and the torques that can be generated by electric motors of a suitable size, it is advantageous for the rotor elements to be connected to the wheel shaft via a first reduction gear. That is to say, the torque acting on the wheel shaft is increased, while its rotational speed in relation to the (optionally matching) rotational speeds of the rotor elements is reduced. If required, the first reduction gear can have one or more reduction stages. These can be implemented, for example, by pairs of spur gears that mesh with one another, but other possibilities also exist.

Likewise in some examples, the secondary stator element is connected to the spring element via a second reduction gear. The expression “second reduction gear” serves merely for terminological distinction and does not imply that the above-mentioned first reduction gear must also be present. The second reduction gear can also have one or more reduction stages. Overall, it has the effect that an angular movement of the secondary stator element leads to a smaller angular movement on the part of the spring element, while a torque acting on the part of the secondary stator element leads to a greater torque on the part of the spring element.

In an example embodiment, a first driving torque can be generated in the first electric motor and a second driving torque that is independent thereof can be generated in the second electric motor, whereby there can be generated a wheel torque in the wheel shaft and a spring torque that is independent thereof and acts at least indirectly on the spring element. That is to say, the drive assembly is designed such that a torque can be generated in the first electric motor, which is referred to as the first driving torque, independently of a torque in the second electric motor, which is referred to as the second driving torque. To this end, the electric motors must be able to be supplied, that is to say must be supplied, with current and/or voltage independently. The drive assembly can also have a control unit, which controls or regulates the supply to the two electric motors. By means of the size and ratio of the two driving torques, on the one hand the wheel torque and on the other hand the spring torque can be adjusted. The spring torque is exerted by the secondary stator element, optionally via the second reduction gear, and acts directly or indirectly on the spring element. For example, it can act on the above-mentioned torsion portion. Overall, the drive and the suspension can in this way be influenced independently of one another. The driving torques necessary to achieve a specific combination of wheel torque and spring torque can be calculated by a control unit or ascertained by means of a look-up table.

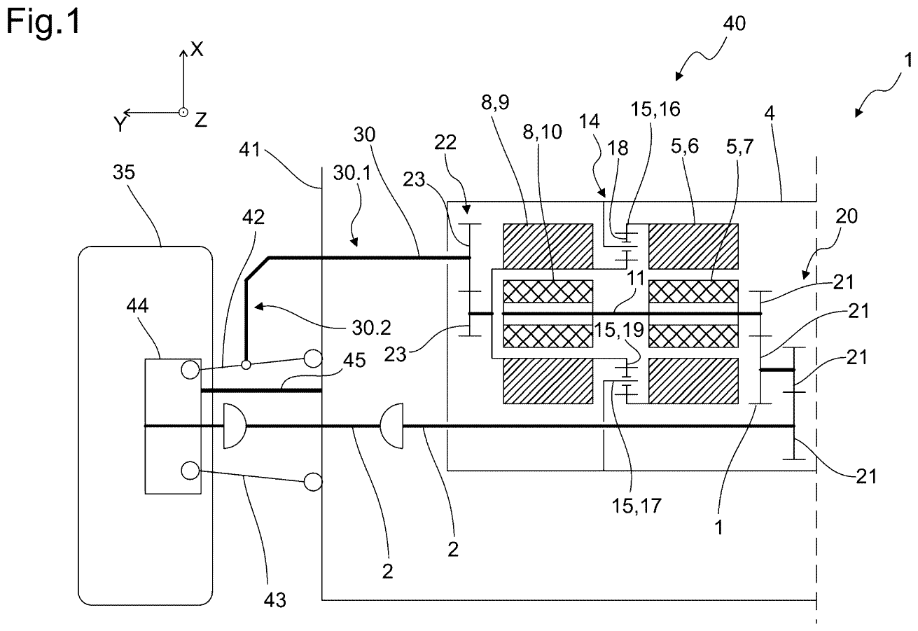

FIG. 1 shows a first embodiment of a drive assembly 1 according to the invention, which is provided for a motor vehicle 40, in this case an electric vehicle. For orientation, a vehicle longitudinal axis X (pointing toward the rear), a vehicle transverse axis Y and a vehicle vertical axis Z are depicted. A wheel carrier 44 is movably attached to a vehicle body 41 via two transverse control arms 42, 43. A vehicle wheel 35 is rotatably mounted on the wheel carrier 44. The vehicle wheel 35 can be driven via a wheel shaft 2. A lever portion 30.2 of a first spring element 30 is connected to a rear transverse control arm 42. The first spring element 30 has a torsion portion 30.1, which extends parallel to the vehicle transverse axis Y and leads to the vehicle body 41. By deflecting the rear transverse control arm 42 relative to the vehicle body 41, the lever portion 30.2 is deflectable, resulting in a changing torsion of the torsion portion 30.1. Conversely, by changing the torsion on the vehicle side, a spring force acting on the wheel carrier 44 and the vehicle wheel 35, and thus a rest position of the vehicle wheel 35, can be influenced. The wheel carrier 44 is additionally connected to the vehicle body 41 via a second spring element 45. The second spring element 45 is here shown purely schematically. It can be configured as a helical spring, leaf spring, torsion spring or in another way. It generates a spring force acting between the vehicle body 41 and the vehicle wheel 35, said spring force acting in addition to the spring force of the first spring element 30.

Connected to the vehicle body 41 is a bearing unit 4, which may also be referred to as a housing. A first electric motor 5 and a second electric motor 8 are rotatably mounted within the bearing unit 4. A primary rotor element 7 of the first electric motor 5 and a secondary rotor element 10 of the second electric motor 8 are mounted coaxially and are non-rotatably connected via a rotor shaft 11. The rotor shaft 11 is further connected in a movement-transmitting manner to the wheel shaft 2 via a plurality of gear wheels 21 of a first reduction gear 20. The wheel shaft 2 and the vehicle wheel 35 can therefore be driven by rotation of the rotor elements 7, 10. A primary rotor element 6 of the first electric motor 5 is non-rotatably connected to a ring gear 16 of a coupling gear 14, which is configured as a planetary gear. A secondary rotor element 9 of the second electric motor 8 is non-rotatably connected to a sun gear 19 of the coupling gear 14. The coupling gear 14 has as gear parts 15, in addition to the ring gear 16 and the sun gear 19, a planet carrier 17, which is non-rotatably connected to the bearing unit 4. A plurality of planet gears 18 are rotatably mounted on the planet carrier 17 and mesh on the one hand with the sun gear 19 and on the other hand with the ring gear 16. The stator elements 6, 9 are thus coupled in a movement-transmitting manner via the coupling gear 14. The secondary stator element is additionally coupled in a movement-transmitting manner to the torsion portion 30.1 via gear wheels 23 of a second reduction gear 22. A first driving torque M1 acting between the primary stator element 6 and the primary rotor element 7 and a second driving torque M2 acting between the secondary stator element 9 and the secondary rotor element 10 can be adjusted independently of one another by a control unit (not shown here). A wheel torque MR can thus be generated in the wheel shaft 2 and a spring torque MF acting on the first spring element 30 can thus be generated with different strengths depending on the situation.

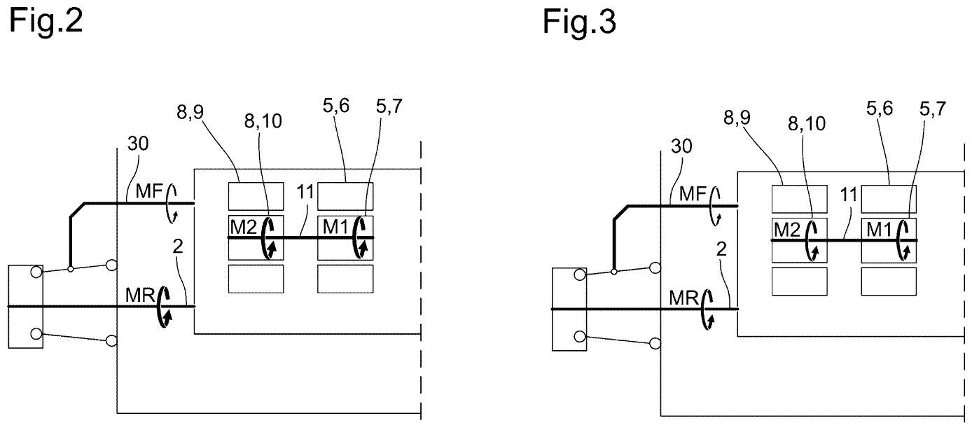

FIG. 2 shows a situation in which a driving wheel torque MR is generated in the wheel shaft 2. Two equal driving torques M1, M2 are here generated in the two electric motors 5, 8. The arrows shown in FIGS. 2 to 5 each show the effective direction of the torque MF, MR, M1, M2, wherein in the case of the driving torques M1, M2 the component acting on the respective rotor 7, 10 is shown. An opposite torque acts on the stator element 6, 9. However, the secondary stator element 9 is subjected not only to the second driving torque M2 but also, via the coupling gear 14, to a torque that originates from the first driving torque M1 and acts against the second driving torque M2. However, owing to the speed increase by the coupling gear 14, the second driving torque M2 is weighted more greatly. There is thus obtained, with the same strength of the driving torques M1, M2, a residual spring torque MF.

Depending on the situation, it can be provided, for example, that the spring torque MF is increased or reduced, for example in order to raise or lower the vehicle body 14 relative to the vehicle wheel 35 without this affecting the wheel torque MR. To this end, the sum of the driving torques M1, M2 must be kept constant, while their difference is changed, which leads to a change in the spring torque MF. The strength of the driving torques M1, M2 that is necessary for a particular spring torque MF can be taken, for example, from a look-up table. Conversely, it can be provided that, with a constant spring torque MF, the wheel torque MR is changed, for example reduced. This is shown in FIG. 3. Compared to FIG. 2, both driving torques M1, M2 are reduced, wherein their ratio is so adjusted that the resulting spring torque MF remains unchanged. Here too, a look-up table can again be used.

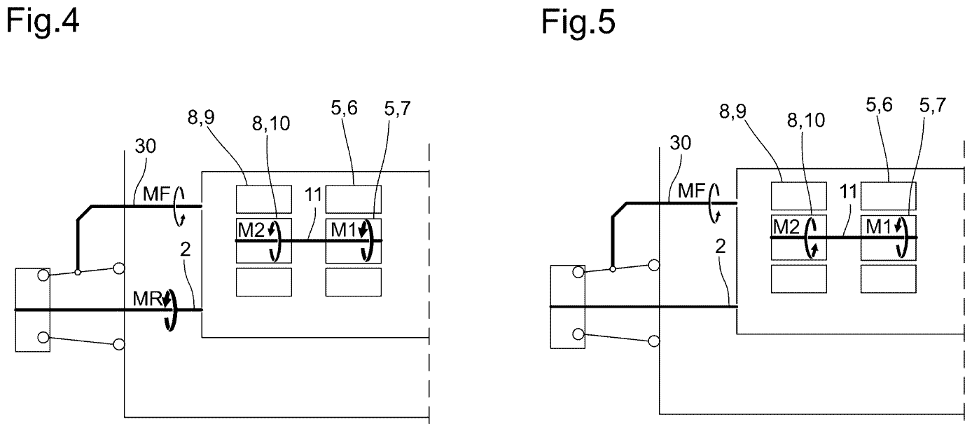

FIG. 4 shows a situation in which the vehicle wheel 35 is braked, for which purpose a braking wheel torque MR is generated in the wheel shaft 2. The driving torques M1, M2 are reversed compared to FIG. 2. However, in order to maintain a spring torque MF in the first spring element 30, the first driving torque 1 must be greater than the second driving torque M2, which is indicated in FIG. 3 by the different line thicknesses of the arrows.

FIG. 5 shows a situation in which the motor vehicle is stopped, for example at traffic lights. The wheel torque MR is equal to zero in this situation. The driving torques M1, M2 are equal in terms of amount, but are opposite. They support one another in their action on the secondary stator element 9. A spring torque MF of the desired strength again results from this action.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A drive assembly for a motor vehicle comprising:
a wheel shaft for non-rotatable connection to a vehicle wheel;
a bearing unit for arrangement on a vehicle body;
a first electric motor having a primary stator element and a primary rotor element; and
a second electric motor having a secondary stator element and a secondary rotor element,
wherein the stator element and the rotor element of each electric motor are rotatable relative to one another,
wherein the rotor elements are coupled in a movement-transmitting manner to the wheel shaft,
wherein the stator elements are mounted so as to be individually rotatable relative to the bearing unit and are connected via a coupling gear, and
wherein the secondary stator element is coupled in a movement-transmitting manner to a spring element for the suspension of the vehicle wheel.

2. The drive assembly of claim 1, wherein the rotor elements are non-rotatably connected to one another.

3. The drive assembly of claim 1, wherein the stator elements are coupled in a movement-transmitting manner via the coupling gear such that a speed reduction takes place from the primary stator element to the secondary stator element.

4. The drive assembly of claim 1, wherein the coupling gear is configured as a planetary gear, which has as gear parts a ring gear, a planet carrier with a plurality of planet gears, and a sun gear.

5. The drive assembly of claim 1, wherein the primary stator element is non-rotatably connected to a first gear part, the secondary stator element is non-rotatably connected to a second gear part, and a third gear part is non-rotatably connected to the bearing unit.

6. The drive assembly of claim 1, wherein the primary stator element is non-rotatably connected to the ring gear, the secondary stator element is non-rotatably connected to the sun gear, and the planet carrier is non-rotatably connected to the bearing unit.

7. The drive assembly of claim 1, wherein the spring element has a torsion portion to which the secondary stator element is coupled in a movement-transmitting manner.

8. The drive assembly of claim 1, wherein the rotor elements are connected via a first reduction gear to the wheel shaft.

9. The drive assembly of claim 1, wherein the secondary stator element is connected via a second reduction gear to the spring element.

10. The drive assembly of claim 1, wherein a first driving torque can be generated in the first electric motor and a second driving torque that is independent thereof can be generated in the second electric motor, whereby there can be generated a wheel torque in the wheel shaft and a spring torque that is independent thereof and acts at least indirectly on the spring element.
